(19) United States
(12) Patent Application Publication
(10) Pub. No.: US 2022/0131452 A1
(43) Pub. Date: Apr. 28, 2022

(54) Motor And Robot

(71) Applicant: Seiko Epson Corporation, Tokyo (JP)

(72) Inventors: Hisako KOJIMA, Kai (JP); Taishi OKITA, Matsumoto (JP)

(21) Appl. No.: 17/509,117

(22) Filed: Oct. 25, 2021

(30) Foreign Application Priority Data
Oct. 26, 2020 (JP) 2020-178711

(51) Int. Cl. H02K 21/24; B25J 9/12

(52) U.S. Cl. CPC H02K 21/24; H02K 2213/03; B25J 9/126

(57) ABSTRACT

A motor includes an annularly-shaped field system having a first main pole magnetized in a first direction along a rotation axis and a second main pole magnetized in a second direction opposite to the first direction, and including a plurality of magnetic poles arrayed along a circumference around the rotation axis, and an armature facing the field system in a direction along the rotation axis, wherein a value of a ratio of an inner diameter to an outer diameter of the field system is within a range from 0.4 to 0.8.

The present application is based on, and claims priority from JP Application Serial Number 2020-178711, filed Oct. 26, 2020, the disclosure of which is hereby incorporated by reference herein in its entirety.

### BACKGROUND

### 1. Technical Field

The present disclosure relates to a motor and a robot.

### 2. Related Art

JP-A-2010-88269 discloses a rotor as an annular-shaped rotor of an axial gap motor, including a magnetic member manufactured using a layered structure formed by wrapping of a tape-like magnetic plate and magnet pieces and substantially having a Halbach structure.

However, dimension ratios of the magnetic pieces etc. are not mentioned in the technique disclosed in JP-A-2010-88269 and, in this regard, room for improvement may be left in output efficiency of the motor.

### SUMMARY

An aspect is directed to a motor including an annularly-shaped field system having a first main pole magnetized in a first direction along a rotation axis and a second main pole magnetized in a second direction opposite to the first direction, and including a plurality of magnetic poles arrayed along a circumference around the rotation axis, and an armature facing the field system in a direction along the rotation axis, wherein a value of a ratio of an inner diameter to an outer diameter of the field system is within a range from 0.4 to 0.8.

Another aspect is directed to a robot including the above described motor.

### BRIEF DESCRIPTION OF THE DRAWINGS

FIG. 1 is a sectional view for explanation of a motor according to a first embodiment.

FIG. 2 is a plan view for explanation of an armature of the motor.

FIG. 3 is a plan view for explanation of a field system of the motor.

FIG. 4 is a sectional view for explanation of magnetization directions of the field systems as seen from line IV-IV in FIG. 3 with respect to each number of poles for a half period.

FIG. 5 is a graph for explanation of internal radius-torque constant characteristics for l=1.

FIG. 6 is a graph for explanation of internal radius-torque constant characteristics for l≥2.

FIG. 7 is a graph for explanation of internal radius-torque constant density characteristics for l=1.

FIG. 8 is a graph for explanation of internal radius-torque constant density characteristics for l≥2.

FIG. 9 is a sectional view for explanation of a motor according to a modified example of the first embodiment.

FIG. 10 is a perspective view for explanation of a robot according to an application example of a motor according to a second embodiment.

### DESCRIPTION OF EXEMPLARY EMBODIMENTS

As below, an embodiment of the present disclosure will be explained with reference to the drawings. The embodiment exemplifies an apparatus and a method for implementing the technical idea of the present disclosure. The technical idea of the present disclosure does not specify materials, shapes, structures, placements, etc. of component elements to the following ones. In the drawings, the same or similar elements respectively have the same or similar signs and the overlapping explanation will be omitted. The drawings show schematic diagrams and may include different ones from real dimensions and relative proportions of dimensions, placements, structures, etc.

### First Embodiment

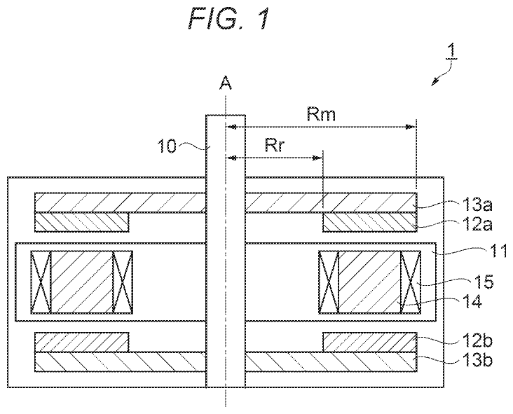

As shown in FIG. 1, a motor 1 according to a first embodiment includes e.g. a shaft 10, an armature 11, a first field system 12a, a first back yoke 13a, a second field system 12b, and a second back yoke 13b. The motor 1 is an axial gap motor in which respective gaps between the armature 11 and the first field system 12a and second field system 12b are defined in directions along the shaft 10, i.e., a rotation axis A. That is, the armature 11 respectively faces the first field system 12a and second field system 12b in the directions along the rotation axis A. The motor 1 includes e.g. the armature 11 as a stator and the first field system 12a and second field system 12b as rotors.

The first field system 12a is placed between the armature 11 and the first back yoke 13a. The second field system 12b is placed between the armature 11 and the second back yoke 13b. The first field system 12a and the second field system 12b have the same structure as each other. In the example shown in FIG. 1, the motor 1 includes a pair of field systems of the first field system 12a and the second field system 12b placed with the armature 11 in between, however, only one field system may be provided. Hereinafter, one of the first field system 12a and the second field system 12b is simply referred to as “field system 12”.

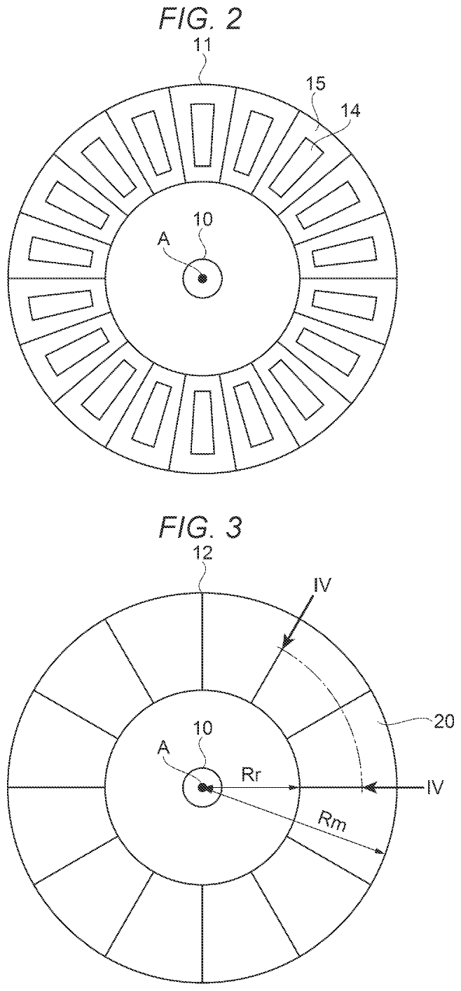

As shown in FIG. 2, the armature 11 substantially has an annular shape. The armature 11 has a plurality of cores 14 and a plurality of coils 15. Each core 14 substantially has a prismatic column shape with a height along the shaft 10. Each core 14 includes a plurality of plates of an amorphous magnetic material stacked in the radial direction of the shaft 10, for example. The plurality of cores 14 are supported by e.g. bobbins and fixed in position relationships with one another. Each coil 15 includes a winding wire wound along the side surface of the core 14.

The number of pairs of the cores 14 and the coils 15 is e.g. 18. The plurality of cores 14 and the plurality of coils 15 are arrayed at equal intervals along the circumference around the rotation axis A to have 18 rotational symmetries with respect to the rotation axis A. For example, currents at three phases of U-phase, V-phase, and W-phase circularly flow in the array direction in the plurality of coils 15.

As shown in FIG. 3, the field system 12 substantially has an annular shape. The field system 12 includes a plurality of magnetic poles 20 arranged along the circumference around the rotation axis A. Each of the plurality of magnetic poles 20 is e.g. a permanent magnet. The surface of the field system 12 may be defined by a curved surface formed by a trajectory of a rectangle having two sides parallel to the rotation axis A and separated from the rotation axis A when the rectangle rotates around the rotation axis A. The plurality of magnetic poles 20 have magnetization directions periodically different in the array direction. The plurality of magnetic poles 20 have a pair of main poles of a first main pole magnetized in a first direction along the rotation axis A and a second main pole magnetized in a second direction opposite to the first direction for one period. The field system 12 includes e.g. the plurality of magnetic poles 20 for six periods per rotation.

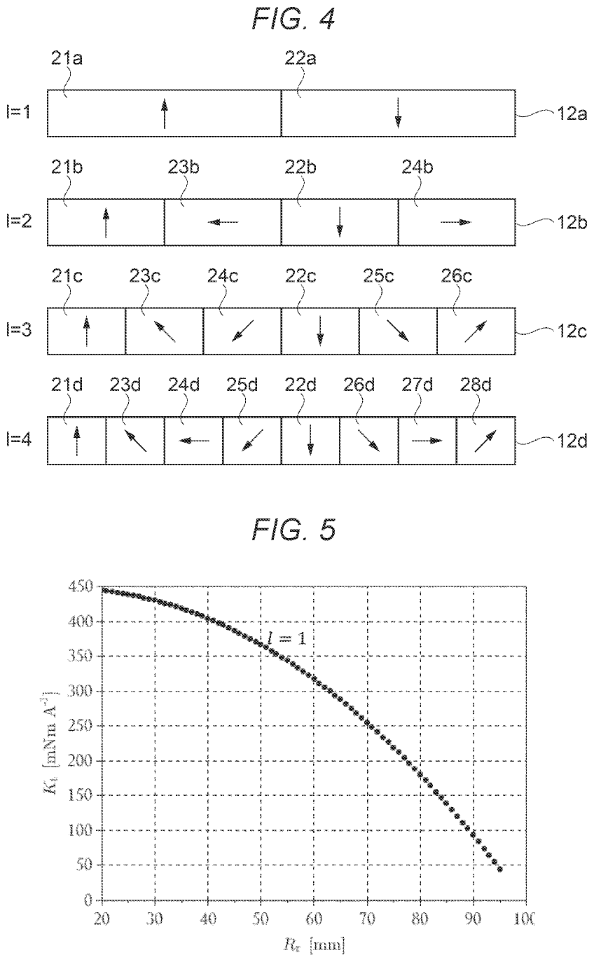

As shown in FIG. 4, when the number of the magnetic poles 20 for a half period in the array direction is 1, the field system 12a for l=1 has a first main pole 21a and a second main pole 22a as two magnetic poles 20 for one period. That is, each of the plurality of magnetic poles 20 of the field system 12a except the first main pole 21a and the second main pole 22a is magnetized in the first direction or the second direction along the rotation axis A.

The field system 12b for l=2 has a first main pole 21b, a first auxiliary pole 23b, a second main pole 22b, and a second auxiliary pole 24b as four magnetic poles 20 for one period. The respective magnetic poles 20 of the field system 12b have magnetization directions different by 90° from the adjacent magnetic poles 20 as seen from the radial direction of the shaft 10. The respective magnetic poles 20 of the field system 12b have the magnetization directions changing to rotate by 90° around an axis in the radial direction of the shaft 10 sequentially in the array direction.

A field system 12c for l=3 has a first main pole 21c, a first auxiliary pole 23c, a second auxiliary pole 24c, a second main pole 22c, a third auxiliary pole 25c, and a fourth auxiliary pole 26c as six magnetic poles 20 for one period. The respective magnetic poles 20 of the field system 12c have magnetization directions different by 60° from the adjacent magnetic poles 20 as seen from the radial direction of the shaft 10. The respective magnetic poles 20 of the field system 12c have the magnetization directions changing to rotate by 60° around the axis in the radial direction of the shaft 10 sequentially in the array direction.

A field system 12d for l=4 has a first main pole 21d, a first auxiliary pole 23d, a second auxiliary pole 24d, a third auxiliary pole 25d, a second main pole 22d, a fourth auxiliary pole 26d, a fifth auxiliary pole 27d, and a sixth auxiliary pole 28d as eight magnetic poles 20 for one period. The respective magnetic poles 20 of the field system 12d have magnetization directions different by 45° from the adjacent magnetic poles 20 as seen from the radial direction of the shaft 10. The respective magnetic poles 20 of the field system 12d have the magnetization directions changing to rotate by 45° around the axis in the radial direction of the shaft 10 sequentially in the array direction.

The plurality of magnetic poles 20 of the respective field systems 12b, 12c, 12d form Halbach arrays. As described above, the plurality of magnetic poles 20 of the field system 12 for l≥2 form the Halbach array. In the motor 1 having the Halbach array, the armature 11 is placed at the high-field side of the Halbach array. That is, in the example shown in FIG. 1, the first field system 12a and the second field system 12b are placed so that the respective high-field sides may face each other.

The motor 1 having the Halbach array may increase magnetic flux density on the surface at the armature 11 side of the Halbach array and the torque constant may be improved. Particularly, when 1 is 3 or 4, changes in magnetic flux density in the array direction may be made smoother and the torque constant may be further improved.

Generally, when a current I flows in a coil, torque T is expressed by Expression (1) using a torque constant Kₜ.

T=KₜI (1)

The torque constant Kₜ is expressed by Expression (2) by definition of a Lorentz force.

$${K}_{t} = pqN sin ( \frac{απ}{3} ) {\int }_{{R}_{r}}^{{R}_{m}} r d r {B}_{1 , l} ( r ) \qquad ( 2 )$$

p is a number of pole pairs, i.e., a number of periods in the array of the plurality of magnetic poles 20. q (=3) is a number of phase of the current flowing in the armature 11. N is a number of turns of the coil 15. α is an opening angle of the coil 15 relative to a slot pitch, i.e., an angle formed by the array pitch of the coil 15 with respect to the rotation axis A. Rᵣ is an internal radius of the field system 12. Rₘ is an external radius of the field system 12. B_{1,l}(r) is fundamental amplitude of magnetic flux density in a gap between the magnetic poles 20 in a first segment.

The torque constant Kₜ per unit volume of the field system 12 is torque constant density Jₜ and expressed by Expression (3).

$${J}_{t} = \frac{{K}_{t}}{π ( {R}_{m}^{2} - {R}_{Γ}^{2} ) {z}_{m}} \qquad ( 3 )$$

where zₘ is a thickness, i.e., a dimension along the rotation axis A of the field system 12.

As shown in FIG. 5, the torque constant Kₜ of the field system 12a for l=1 decreases as the internal radius Rᵣ increases. The torque constant Kₜ is calculated from Expression (2). Here, p=36, g=0.5 mm, Rₘ is 100 mm, and the same applies to the following description. g refers to a gap between the field system 12a and the armature 11.

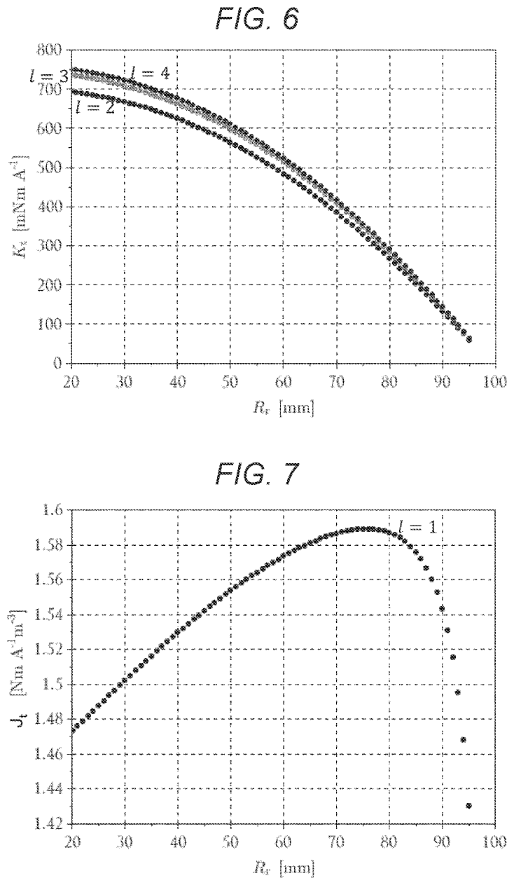

As shown in FIG. 6, the torque constant Kₜ of the field system 12b for l=2 is significantly larger than the torque constant Kₜ of the field system 12a and decreases as the internal radius Rᵣ increases. When Rᵣ=20, the torque constant Kₜ of the field system 12a is about 450 mNmA⁻¹, and the torque constant Kₜ of the field system 12b is about 700 mNmA⁻¹.

The torque constant Kₜ of the field system 12c for l=3 is larger than the torque constant Kₜ of the field system 12b and decreases as the internal radius Rᵣ increases. When Rᵣ=20, the torque constant Kₜ of the field system 12c is about 740 mNmA⁻¹. The torque constant Kₜ of the field system 12d for l=4 is slightly larger than the torque constant Kₜ of the field system 12c and decreases as the internal radius Rᵣ increases. When Rᵣ=20, the torque constant Kₜ of the field system 12d is about 750 mNmA⁻¹. The torque constants Kₜ of the respective field systems 12 decrease as the internal radius Rᵣ increases and converge toward zero.

As shown in FIG. 7, the torque constant density Jₜ of the field system 12a for l=1 takes a local maximum value at about 1.59 NmA⁻¹ m⁻³ when the internal radius Rᵣ is about 75 mm. That is, the torque constant density Jₜ of the field system 12a is the local maximum value when a value V_{R} of a ratio of an inner diameter to an outer diameter of the field system 12a is about 0.75. As described above, regarding the field system 12a, when the value V_{R} of the ratio is substantially in a range from 0.7 to 0.8, the torque constant density Jₜ takes a value close to the local maximum value. The value V_{R} of the ratio is adjusted, and thereby, output efficiency of the motor 1 referring to the torque T relative to the input current I may be improved.

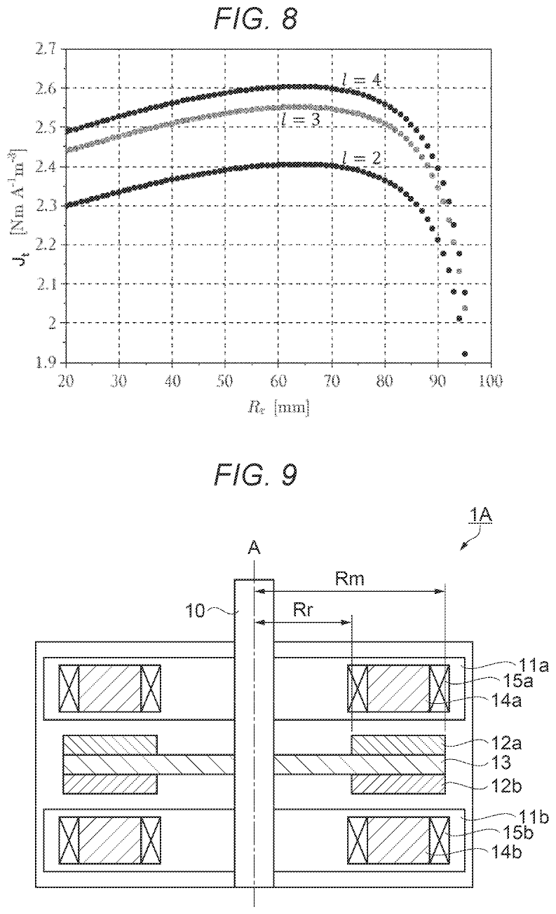

As shown in FIG. 8, the torque constant density Jₜ of the field system 12b for l=2 takes a local maximum value at about 2.4 NmA⁻¹ m⁻³ when the internal radius Rᵣ is about 65 mm. That is, the torque constant density Jₜ of the field system 12b is the local maximum value significantly larger than the torque constant density Jₜ of the field system 12a when the value V_{R} of a ratio of an inner diameter to an outer diameter of the field system 12b is about 0.65. When the value V_{R} of the ratio is substantially in a range from 0.4 to 0.8, the torque constant density Jₜ of the field system 12b takes a value close to the local maximum value. More preferably, when the value V_{R} of the ratio is substantially in a range from 0.55 to 0.75, the torque constant density Jₜ of the field system 12b takes a value closer to the local maximum value. The value V_{R} of the ratio is adjusted, and thereby, the output efficiency of the motor 1 referring to the torque T relative to the input current I may be improved.

The torque constant density Jₜ of the field system 12c for l=3 takes a local maximum value at about 2.55 NmA⁻¹ m⁻³ when the internal radius Rᵣ is about 65 mm. That is, the torque constant density Jₜ of the field system 12c is the local maximum value larger than the torque constant density Jₜ of the field system 12b when the value V_{R} of a ratio of an inner diameter to an outer diameter of the field system 12c is about 0.65. When the value V_{R} of the ratio is substantially in a range from 0.4 to 0.8, the torque constant density Jₜ of the field system 12c takes a value close to the local maximum value. More preferably, when the value V_{R} of the ratio is substantially in a range from 0.55 to 0.75, the torque constant density Jₜ of the field system 12c takes a value closer to the local maximum value. The value V_{R} of the ratio is adjusted, and thereby, the output efficiency of the motor 1 referring to the torque T relative to the input current I may be improved.

The torque constant density Jₜ of the field system 12d for l=4 takes a local maximum value at about 2.6 NmA⁻¹ m³ when the internal radius Rᵣ is about 65 mm. That is, the torque constant density Jₜ of the field system 12d is the local maximum value slightly larger than the torque constant density Jₜ of the field system 12c when the value V_{R} of a ratio of an inner diameter to an outer diameter of the field system 12d is about 0.65. When the value V_{R} of the ratio is substantially in a range from 0.4 to 0.8, the torque constant density Jₜ of the field system 12d takes a value close to the local maximum value. More preferably, when the value V_{R} of the ratio is substantially in a range from 0.55 to 0.75, the torque constant density Jₜ of the field system 12d takes a value closer to the local maximum value. The value V_{R} of the ratio is adjusted, and thereby, the output efficiency of the motor 1 referring to the torque T relative to the input current I may be improved.

As described above, when the value V_{R} of the ratio is substantially in the range from 0.4 to 0.8, the output efficiency of the motor 1 referring to the torque T relative to the input current I may be improved. That is, the current I for obtaining the constant torque T may be reduced and power consumption proportional to the square of the current I may be reduced. Further, the weight of the motor 1 may be reduced by adjustment of the value V_{R} of the ratio so that the torque constant density Jₜ may be substantially the local maximum value. Thereby, for example, when the motor 1 is provided in a mobile robot, an electric car, or the like, the motor can contribute to extension of a cruising range and operating hours, improvement of acceleration and deceleration performance, reduction of the manufacturing cost, etc.

### Modified Example

As shown in FIG. 9, a motor 1A according to a modified example of the first embodiment includes the shaft 10, a first armature 11a, the first field system 12a, a back yoke 13, the second field system 12b, and a second armature 11b. The motor 1A is an axial gap motor like the motor 1, however, different from the motor 1 in that the first field system 12a and the second field system 12b and the back yoke 13 as one rotor are placed between the first armature 11a and the second armature 11b respectively as stators. The configurations, the functions, and the effects not described in the modified example are the same as those of the above described first embodiment and omitted to avoid overlap.

The first armature 11a and the second armature 11b have the same structure as each other. That is, the first armature 11a has a plurality of cores 14a and a plurality of coils 15a. The second armature 11b has a plurality of the cores 14b and a plurality of the coils 15b like the plurality of cores 14a and the plurality of coils 15a. The first armature 11a faces the first field system 12a in the direction along the rotation axis A. Similarly, the second armature 11b faces the second field system 12b in the direction along the rotation axis A.

### Second Embodiment

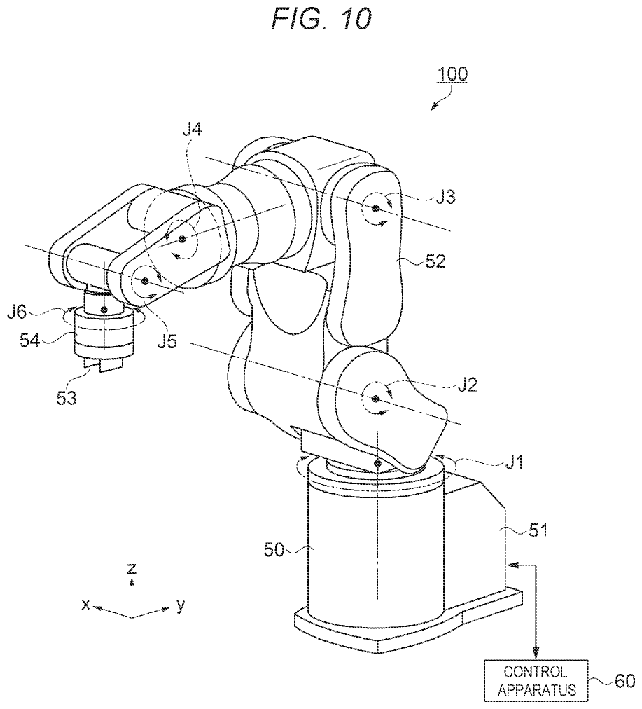

As shown in FIG. 10, a robot system 100 according to a second embodiment includes e.g. a robot 50 and a control apparatus 60. The robot 50 has e.g. a base 51 and a plurality of joints J1 to J6, and includes a manipulator 52 supported by the base 51, an end effector 53, and a force sensor 54. As the robot 50, e.g. a general-purpose robot that can perform various kinds of work according to programs generated by a teaching apparatus (not shown) may be employed. The robot 50 may be a mobile robot having a moving platform such as an automated guided vehicle (AGV) or an autonomous mobile robot (AMR).

The manipulator 52 is a robotic arm moving at six degrees of freedom having e.g. seven links mutually coupled by the six joints J1 to J6. In the example shown in FIG. 10, the manipulator 52 is a six-axis arm including the six joints J1 to J6 respectively as rotary joints. The manipulator 52 may have any joint mechanism as long as the joint mechanism has a plurality of joints.

The end effector 53 is a tool e.g. a screw driver, a gripper, a grinder, or the like. The end effector 53 performs various kinds of work e.g. screwing, gripping, grinding, etc. The end effector 53 is attached to a mechanical interface at the distal end of the manipulator 52 via the force sensor 54. The manipulator 52 is drive-controlled by the control apparatus 60, and thereby, determines position and attitude, i.e., pose of the end effector 53.

The force sensor 54 detects an external force acting on a tool center point (TCP) as a reference for the position of the end effector 53 via e.g. the end effector 53. Specifically, the force sensor 54 outputs a signal representing the external force to the control apparatus 60, and thereby, in the control apparatus 60, forces along three detection axes and torque about the three detection axes acting on the TCP are detected as the external force. The three detection axes form a world coordinate system defined by e.g. an x-axis, a y-axis, and a z-axis orthogonal to one another.

At least one of the plurality of joints J1 to J6 may have the motor 1 and an encoder that detects the rotation angle of the motor 1. The motor 1 is driven by control of the control apparatus 60, and thereby, drives the joint having the motor 1 of the joints J1 to J6. The encoder detects and outputs the rotation angle of the motor 1 to the control apparatus 60.

The control apparatus 60 includes a processing circuit and a memory circuit forming a computer system. For example, the processing circuit realizes the respective functions described in the embodiment by executing a control program stored in the memory circuit. The memory circuit is a computer-readable memory medium that stores control programs showing a series of processing and various kinds of data necessary for the operation of the robot system 100.

According to the robot system 100, the motor 1 according to the first embodiment that can improve the output efficiency is provided, and thereby, motion performance including a velocity, an acceleration, jerk, and a motion range of the manipulator 52 may be improved. Further, when the robot 50 is a mobile robot having a moving platform moving by driving of the motor 1, the motor 1 can contribute to extension of a cruising range and operating hours, improvement of acceleration and deceleration performance, etc.

### OTHER EMBODIMENTS

As above, the embodiments are explained, however, the present disclosure is not limited to these disclosures. The configurations of the respective parts may be replaced by arbitrary configurations having the same functions, and arbitrary configurations in the respective embodiments may be omitted or added within the technical scope of the present disclosure. From these disclosures, various alternative embodiments will be clear to those skilled in the art.

For example, the motor 1 may be applied, not only to a robot, an electric car, or the like but to various apparatuses as an actuator that generates rotational motion. Further, the numbers of the manipulators 52 and the end effectors 53 provided in the robot 50, the degree of freedom of the manipulator 52, or the like may be arbitrarily changed. The robot 50 may be a Cartesian coordinate robot, a horizontal articulated robot, a vertical articulated robot, a dual-arm robot, or the like.

In addition, the present disclosure obviously includes various embodiments not described as above such as configurations formed by mutual application of the above described respective configurations. The technical scope of the present disclosure is defined only by the matters used to specify the invention according to the appended claims appropriate from the above explanation.

What is claimed is:

1. A motor comprising:
an annularly-shaped field system having a first main pole magnetized in a first direction along a rotation axis and a second main pole magnetized in a second direction opposite to the first direction, and including a plurality of magnetic poles arrayed along a circumference around the rotation axis; and
an armature facing the field system in a direction along the rotation axis, wherein
a value of a ratio of an inner diameter to an outer diameter of the field system is within a range from 0.4 to 0.8.

2. The motor according to claim 1, wherein
the respective plurality of magnetic poles are magnetized in the first direction or the second direction, and
the value of the ratio is within a range from 0.7 to 0.8.

3. The motor according to claim 1, wherein
the plurality of magnetic poles form a Halbach array, and
the value of the ratio is within a range from 0.55 to 0.75.

4. The motor according to claim 1, further comprising:
another field system having a same structure as the field system; and
another armature facing the other field system in the direction along the rotation axis, wherein
the field system and the other field system are placed between the armature and the other armature.

5. A robot comprising the motor according to claim 1.
